(19) United States
(12) Patent Application Publication
(10) Pub. No.: US 2009/0265096 A1
(43) Pub. Date: Oct. 22, 2009

(54) TWO-STEP ROUTING PROCEDURE

(76) Inventors: Niko Haatainen, Nilsia (FI); Samuli Mattila, Berlin (DE); Miika Lappalainen, Berlin (DE)

Correspondence Address: Fay Sharpe LLP, 1228 Euclid Avenue, 5th Floor, The Halle Building, Cleveland, OH, 44115, US

(21) Appl. No.: 12/159,996

(22) PCT Filed: Jan. 2, 2007
(86) PCT No.: PCT/FI07/00001

§ 371 Date: Mar. 16, 2009

(30) Foreign Application Priority Data
Jan. 3, 2006 (FI) 20060008

(51) Int. Cl. G01C 21/34

(52) U.S. Cl. 701/201

(57) ABSTRACT

The route computing method and software using a two-step routing procedure. First the navigation software computes a temporary route using road segments having a predetermined road classification. This simplifies the routing as the amount of the roads is minimized. The result is rough and it must be further computed for achieving the best possible result. For computing the best possible result the navigation software determines a distance parameter. The parameter determines the distance that is used for further computing from the temporary route. Then the further computation can be focused on a geographical area with a complete set of roads and streets.

### FIELD OF THE INVENTION

The invention relates to navigation devices. The invention relates particularly to an enhanced routing method and system for navigation devices.

### BACKGROUND OF THE INVENTION

Navigation systems have been developed for assisting drivers to reach a desired destination. The user of such a system inputs the desired destination to the navigation device. As a response the system requests the current location coordinates of the navigation device from a positioning device, which is typically a GPS receiver. The navigation device then computes the route from the current location to the destination. The user of a navigation device is then guided to the destination, for example, via the fastest route. Traditionally navigation devices comprise all the information and software required for computing the route even if the navigation device is, in most cases, a cellular phone or PDA device that has network connectivity means. This kind of implementation is known as on-board design. In off-board implementations the route is computed in a separate navigation server that sends the information back to the navigation device. Both of the implementations have their benefits and most likely a hybrid implementation with combination of on-board and off-board characteristics will be preferred in the future.

The road network is modeled as a weighed graph that includes further information depending on traffic rules, for example, prohibited directions. Besides the weight that typically is a classification for a road or street, the edges of the graph have a length that equals to the length of a road or street segment between two junctions. Based on the information in the graph the navigation software can calculate the desired route, such as the shortest one or the fastest one between two locations.

In classical data processing science this problem is known as the shortest path problem. A famous algorithm for solving this problem is Dijkstra's algorithm. The algorithm can be used for finding the shortest route and with some modifications the fastest or any other desired route type. The modified algorithms serve this purpose quite well. However, as the real life graphs in map applications are huge, for example millions of nodes, there are certain needs for the routing. For example, the routing might be limited to roads and streets having or exceeding a predetermined road classification. If there are no special connections between the current location and the destination, this algorithm works fine. However, there might be ferries, tunnels or other obstacles on the route. If the user is willing to use the ferry or tunnel, the algorithm works fine. However, if the user is not willing to use the ferry or tunnel for some reason, for example vehicle size limitations or other reason, the route might be very long. For example in the Alps, if the user is not willing to go via tunnel and cannot use the high mountain roads, the only option is to go around the mountains. Similarly, if the user is wishing to go from Stockholm to Helsinki, he/she must drive quite a long way in case the ferry is not an option.

In the case mentioned above the routing can be performed by choosing only the biggest roads for the routing procedure. Otherwise there would be too many roads, which means a large amount of edges in the graph to be processed. In many cases this might lead to a bad routing result near the starting location as the roads having required classification might start out of city limits. Similar problems might be encountered also in the destination. This is particularly the case in on-board solutions where the navigation device computes the whole route. Typically these navigation devices are mobile phones that are capable of executing software applications. However, the computing power of such devices is limited and a perfect routing result would require a lot of computing power. Thus, the limitation to the bigger roads must be done.

For understanding the invention better, it should be understood that navigation devices, particularly the mobile phones that are equipped with navigation software and positioning means, are capable of executing software applications. Thus, the navigation device has common means required for executing a program, such as a central processing unit and a memory. However, these are common features in present navigation and mobile devices and are not presented herein as they are well known to a person skilled in the art.

### PURPOSE OF THE INVENTION

The purpose of the invention is to disclose an enhanced routing method and system for navigation devices.

### SUMMARY OF THE INVENTION

The invention discloses a method for generating a route in a navigation device for guiding a user from the current location to a destination. In the method a navigation device computes a route upon request. The request comprises the destination and possible stopover points. Furthermore, the device is arranged to acquire the current location of the navigation device for computing the route. For acquiring the current location the navigation device can use an external positioning device, such as a GPS module, or the positioning means can be integrated to the navigation device. Then the navigation device guides the user from the current location to the desired destination via possible stopover points. Typically the invention is implemented as a navigation software that can be executed in navigation device, such a mobile device.

The route computing according to the present invention is done with a two-step procedure. First the navigation software computes a temporary route using road segments having a predetermined road classification, which means typically bigger roads or streets. This simplifies the routing as the amount of the roads is minimized. The result is rough and it must be further computed for achieving the best possible result. For computing the best possible result the navigation software determines a distance parameter. The parameter determines the distance that is used for further computing from the temporary route. Then the further computation can be focused on a geographical area with a complete set of roads and streets. Lastly, the navigation device guides the user to the destination along the final computed route.

The benefit of the invention is to guarantee fast and acceptable routing results by using two different limited sets of roads. The intersection of the limited sets includes all of the necessary roads and streets for computing the best possible route. However, the amount of roads and streets in these two different sets is only a fraction of the roads and streets of the whole map.

The present invention is particularly beneficial when the desired route is not the one that is commonly considered as the best solution. Typically this means a situation where the distance between the current location and the destination is not far as the crow flies but the actual driving is much longer because of some obstacles. These obstacles might be, for example, a sea gulf where there is no ferry connection available or the user is not wishing to use it, mountains having tunnels or passes that cannot be driven with the vehicle the user is driving, or the road has been closed because of flooding or avalanche danger. There are also other reasons the most common being that the user is just wishing to choose the longer route for some reason even if there are no actual reason that would prevent the user from using the conventional route.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is an illustration of an example embodiment according to the invention,

FIG. 2 is a flow chart of a method according to the present invention.

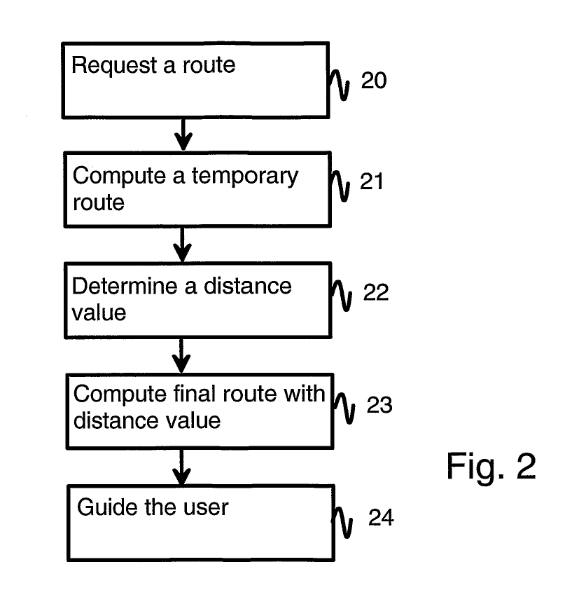

### DETAILED DESCRIPTION OF THE INVENTION

Reference will now be made in detail to the embodiments of the present invention, examples of which are illustrated in the accompanying drawings.

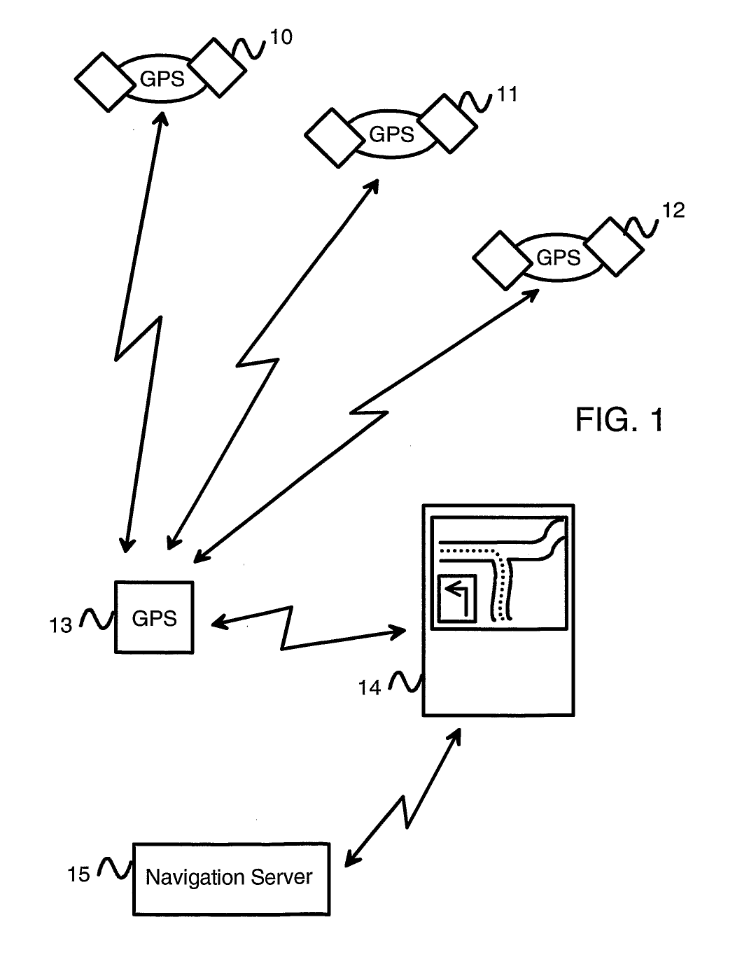

In FIG. 1 an illustration of a navigation system according to the invention is provided. The embodiment of FIG. 1 does not need an external server for a two-step routing procedure according to the present invention in case the system is implemented as an on-board implementation. Even if the benefits of the present invention are better detectable in devices with low computing capacity, the present invention can be used also with an off-board solution wherein a powerful navigation server 15 computes the route. In this document we use an on-board implementation as an example. However, the modifications required for an off-board implementation are obvious to a person skilled in the art. Thus, it should be understood that the present invention works and covers conventional navigation devices.

In the example of FIG. 1 the navigation device 14 does not have a built-in positioning device but is connected wirelessly to a GPS receiver 13 that computes the exact location of the receiver 13 from the observations received from the GPS satellites 10, 11 and 12. The GPS system is used in this example because it is most commonly used, exact and because there are plenty of hardware implementations. However, for the routing features according to the present invention any kind of positioning system is acceptable. Typically the navigation device 14 is a portable device, preferably a mobile phone or other mobile device comprising data communications means. However, the data communication means are necessary only when the invention is implemented as an off-board implementation. In on-board implementations the invention does not use the data communication means and can operate even when the network is not available.

In a method according to the invention the method is initiated by requesting a route, step 20. This is a common feature of navigation devices as their purpose is to guide a user of the device from the current location to a desired destination. The actual computing of the route is then initiated with a limited set of roads and streets, step 21. This set includes only the major roads and streets. Thus, the graph for storing the road network information can be simplified and reduced in size. The result of this computation is a temporary route that is used as a basis for further computations.

After computing the temporary route a distance parameter is determined, step 22. This can be determined in various ways, for example by setting a constant value, such as 50 kilometers or a relative value, such as 5 percent of the route length. The distance parameter determination can be also a combination of constant and relative, such as 5 percent or at least 50 kilometers. The parameter determining method can be device dependent or map dependent. If there is no map dependent method available, the device will use a default method that is typically device dependent or user defined.

At this stage the distance parameter is used for restricting a second limited set of roads. This time the limitation is done with the distance parameter. Thus, the road network available for the second computation is complete within the distance indicated by the distance parameter from the temporary route. With this limitation the final route is computed, step 23. This allows the second computation to produce a route that is optimal also in those parts that do not have roads big enough for the first computation. When the final route is computed, the navigation device can start guiding the user, step 24.

In a preferred embodiment the implementation comprises a mobile phone or other mobile device that is capable of executing a navigation software application. The navigation device has been connected to a GPS receiver with a wireless connection, such as Blue-tooth, or has been built into the navigation device. The navigation database is stored on a memory card. Data communication features, that are typically packet switched, are not used unless the route is calculated in a navigation server which then sends the computed route to the navigation device.

The navigation application according to the invention is arranged to guide a user from the current location to a desired destination. The user inputs the desired destination to the device and the navigation device acquires the current location for computing the route. The present invention is more beneficial when the route itself is not the one that is commonly considered as the best solution. Typically this means a situation where the distance between the current location and the destination is not far as the crow flies but the actual driving is much longer because of obstacles. These obstacles might be, for example, a sea gulf where there is no ferry connection available or the user is not wishing to use it, mountains having tunnels or passes that cannot be driven with the vehicle the user is driving, or the road has been closed because of flooding or avalanche danger. There are also other reasons the most common being that the user is just wishing to choose the longer route for some reason even if there is no actual reason that would prevent the user from using the conventional route.

Thus, the route is further determined by choosing a stopover points or by selecting from the suggestion computed by the navigation device. To provide optional routes the navigation device computes them as described above for computing a temporary route. Then the user chooses from a set of temporary routes the one he/she is wishing to use. Then the navigation device determines the distance parameter and computes the final route. The similar procedure may take place during the guiding procedure. For example, if the navigation device is capable of receiving further information, such as weather and traffic reports, the device might recommend changing the route. The recomputation of the route can be performed by using the two-step procedure according to the present invention. However, this is not mandatory as the user might be driving on a road that is a part of the reduced set having a high priority. Naturally the recomputation must be done also in cases when the driver drives incorrectly or there is a defect in the navigation data that forces the driver to driver differently. However, in these cases conventional recomputation is preferred. The temporary route computed with the limited set of roads can be preserved for recomputations.

The preferred embodiment of the present invention may be implemented as a navigation software that is embodied on a computer readable medium, such as for example, a memory card, compact disc or DVD disc, or the software application can be downloaded from the Internet.

It is obvious to a person skilled in the art that with the advancement of technology, the basic idea of the invention may be implemented in various ways. The invention and its embodiments are thus not limited to the examples described above; instead they may vary within the scope of the claims.

1. A method for generating a route in a navigation device for guiding a user from the current location to a destination, which method comprises the steps of:
choosing the destination;
acquiring the current location;
computing a route from the current location to the destination; and
guiding the user along said route;
characterized in that the computing the route further comprises steps of:
computing a temporary route from the current location to the destination with a limited set of roads;
determining a distance parameter based on said computed temporary route; and
computing a final route using a full set of the roads within said determined distance parameter from the temporary route.

2. A method according to claim 1, characterized in that computing the route from the current location to the destination via at least one stopover point.

3. A method according to claim 1, characterized in that said distance parameter is a fixed distance.

4. A method according to claim 1, characterized in that said distance parameter is a relative distance value computed from the total length of the temporary route.

5. A method according to claim 1, characterized in that the distance parameter determination method is map dependent.

6. A navigation device for guiding the user from the current location to a destination, the navigation device (14) being capable of executing a software application and arranged to communicate with a positioning module (13) for receiving the current location of the device, the navigation device comprising a navigation database, which navigation device is further arranged to:
compute a route from the current position to a destination upon request; and
guide the user of the navigation device according to said computed route;
characterized in that the system is further arranged to:
compute a temporary route from the current location to the destination with a limited set of roads;
determine a distance parameter based on said computed temporary route; and
compute a final route using a full set of the roads within said determined distance parameter from the temporary route.

7. A navigation device according to claim 6, characterized in that the navigation device is further arranged to compute the route from the current location to the destination via at least one stopover point.

8. A navigation device according to claim 6, characterized in that said distance parameter is a fixed distance.

9. A navigation device according to claim 6, characterized in that said distance parameter is a relative distance value computed from the total length of the temporary route.

10. A navigation device according to claim 6, characterized in that the distance parameter determination method is map dependent.

11. A navigation device according to claim 6, characterized in that the positioning module (13) is integrated into the navigation device (14).

12. A navigation software application for guiding the user from the current location to a destination, the software application, when executed in a navigation device, arranged to perform the following steps of:
computing a route from the current position to a destination upon request; and
guiding the user of the navigation device according to said computed route;
characterized in that the software is further arranged to perform steps of:
computing a temporary route from the current location to the destination with a limited set of roads;
determining a distance parameter based on said computed temporary route; and
computing a final route using a full set of the roads within said determined distance parameter from the temporary route.

13. A navigation software application according to claim 12, characterized in that computing the route from the current location to the destination via at least one stopover point.

14. A navigation software application according to claim 12, characterized in that said distance parameter is a fixed distance.

15. A navigation software application according to claim 12, characterized in that said distance parameter is a relative distance value computed from the total length of the temporary route.

16. A navigation software application according to claim 12, characterized in that the distance parameter determination method is map dependent.
